(19) United States
(12) Patent Application Publication
(10) Pub. No.: US 2005/0258093 A1
(43) Pub. Date: Nov. 24, 2005

(54) Antimicrobial activated carbon and method of making

(75) Inventors: Glenn F. Cueman, Davidson, NC (US); Arvind S. Patil, Davidson, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: MICROBAN PRODUCTS COMPANY, Huntersville, NC (US)

(21) Appl. No.: 11/135,239

(22) Filed: May 23, 2005

Related U.S. Application Data
(60) Provisional application No. 60/573,879, filed on May 24, 2004.

(51) Int. Cl. C02F 1/42

(52) U.S. Cl. 210/501

(57) ABSTRACT

A granular activated carbon consists essentially of particles of activated carbon, and less than 1% by weight of an antimicrobial agent, wherein said antimicrobial agent does not desorb from said particles when washed in a polar solvent. Additionally, a method of making a granular activated carbon that exhibits antimicrobial properties is also disclosed.

### CROSS-REFERENCE TO RELATED APPLICATIONS

This application claims the benefit of U.S. Provisional Application No. 60/573,879, filed on May 24, 2004, and herein incorporated by reference.

### FIELD OF THE INVENTION

The present invention relates generally to filters for the purification of liquids. In particular, the present invention relates to a filter media for use in a water filter.

### BACKGROUND OF THE INVENTION

In recent years, the public has become increasingly aware of the deteriorating quality of our nation's and the world's water supply. Pollutants, biological and toxic waste and other contaminants are being introduced into water supplies at an ever increasing rate, making such water supplies unfit for drinking and other necessary uses. For example, medical patients with low immunity are now requested not to drink tap water, and disease and illnesses linked to poor quality drinking water have increased dramatically in recent years. This problem is especially significant outside the United States where water quality has deteriorated to an all time low, with the major source of such contamination primarily being bacterial in nature.

Activated carbon is widely and extensively used in the treatment of drinking water, industrial water, and wastewater. Activated carbon has a very high surface area and its adsorptive and absorptive properties make it one of the most cost effective materials for removing a wide range of water contaminates. Activated carbon is very efficient at removing chlorine from water to improve taste and odor. It is also capable of removing pesticides, chlorinated organics, and many kinds of organic compounds that go under the broad category of Volatile Organic Carbon (VOC).

Unfortunately, activated carbon provides a readily available source of nutrient carbon for bacteria thus encouraging the growth of massive numbers of bacteria on its surface. Under certain conditions the quantity of bacteria growing on activated carbon can double every 20-30 minutes. Most of the bacteria that require carbon as a source of food for their growth are called Heterotrophic bacteria. Common species of Heterotrophic bacteria found growing in activated carbon filter media include, but are not limited to, Acinetobacter species, Aeromonas species, Alcaligenes species, Comamonas species, Enterobacter species, Flavobacteria species, Klebsiella species, Moraxella species, Pseudomonas species, Sphingomonas species, Stenotrophomonas species, Mycobacteria species, and Bacillus species. Many heterotrophic bacteria live in a commensal relationship with humans, but some of the same bacteria act as opportunistic pathogens that cause diseases in immuno-compromised individuals.

Heterotrophic bacteria also form protective colonies, commonly called “biofilms”, which shield some of these opportunistic bacteria from disinfecting agents. Bacteria sheltered in the biofilm also release toxins, some of which are harmful to human beings. Furthermore, even though the presence of high numbers of heterotrophic bacteria may not be that harmful to healthy individuals, even the most benign form of heterotrophic bacteria start imparting unpleasant taste to drinking water when bacteria concentrations reach about 100,000 Colony Forming Units (CFU) per milliliter of water. For these and other reasons, it is very desirable to protect activated carbon filter media from the growth of bacteria and other microbes.

Much of Applicant's prior work has been in the field of antimicrobial protection of fluid filter media. For example, U.S. Pat. No. 6,854,601, commonly assigned with the present invention, discusses bacteriostatic treatment of filter cores made from extruded activated carbon. The process of extruding activated carbon cores is discussed in U.S. Pat. Nos. 5,189,092; 5,249,948; and 5,331,037. The '601 Patent teaches, among other things, how to impart antimicrobial characteristics to extruded carbon cores by adding antimicrobial agents to polymeric binders used in the process of consolidation and extrudation of the activated carbon core.

Although many applications of activated carbon in water treatment involve use of extruded cores, there are equally if not more instances where granular activated carbon is used in consumer, industrial, and waste water treatment applications. In fact, most of the industrial and municipal use of granular activated carbon (GAC) is in the form of granular powders of various mesh sizes. Protection of these granular carbon filters from bacterial contamination is of utmost importance.

One known method for protecting GAC from microbial contamination is to impregnate it with silver. Silver is a widely used antimicrobial additive. Impregnating GAC with silver, however, can be difficult and silver is quite expensive. Furthermore, many of these GAC's are designed to release silver into the surrounding environment which can be undesirable in many circumstances. Accordingly, commercial users of GAC desire an alternative means of protecting GAC.

Another commonly used method to protect GAC from microbes is to place an antimicrobial device upstream of the GAC. This method is the subject of several patents and published patent applications such as WO 01/23307. This method of providing microbial protection for GAC is undesirable because it adds another level of complexity to the overall fluid treatment system.

Thus there is a need for a GAC filter media that exhibits built-in antimicrobial protection but does not rely upon the use of expensive silver or upstream protective measures.

### SUMMARY OF THE INVENTION

In one embodiment, the invention is a granular activated carbon consisting essentially of particles of activated carbon, and less than 1% by weight of an antimicrobial agent, wherein said antimicrobial agent does not desorb from said particles when washed in a polar solvent.

In another embodiment, the invention is a method of making granular activated carbon that exhibits antimicrobial properties. The method comprises solubilizing a predetermined quantity of an antimicrobial agent, and contacting the solubilized antimicrobial agent with particles of granular activated carbon.

In yet a further embodiment, the invention is a method of making a granular activated carbon that exhibits antimicrobial properties. The method comprises melting an antimicrobial agent, and contacting the antimicrobial agent with particles of granular activated carbon.

### DETAILED DESCRIPTION

In very general terms, one embodiment of the invention is a new form of GAC that exhibits antimicrobial properties. In particular, this GAC has built-in antimicrobial properties that last for the useful life of the GAC. Furthermore, the GAC provides antimicrobial benefits without leaching detectable levels of antimicrobial agents into water.

Another embodiment of the invention is a method of making this antimicrobial GAC. Both embodiments are discussed in the paragraphs that follow.

As used herein, the term “antimicrobial agent” includes any number of antimicrobial agents that are commonly identified as organic antimicrobial agents. The term also includes organo-metallic antimicrobial agents. The term “antimicrobial agent”, as used herein, does not include silver. Preferred antimicrobial agents are those that are insoluble or only slightly soluble in water.

Preferred antimicrobial agents include chlorinated phenols such as 2,4,4′-trichloro-2′-hydroxy diphenol ether and 5-chloro-2-phenol (2,4-dichlorophenoxy), commonly known as triclosan. Triclosan is commercially available from a number of sources including Microban Products Company of Huntersville, N.C., who sells it under the tradename MICROBAN B™.

Another preferred antimicrobial agent is poly(hexamethylene biguanide) hydrochloride, commonly known as PHMB. PHMB is commercially available from a number of sources such as Zeneca, Inc. of Wilmington, Del. who sells it under the tradename of COSMOCIL CQ™.

It is also within the scope of the present invention to use other antimicrobial agents including, but not limited to, 2-phenylphenol; diiodomethyl-4-tolylsulfone; zinc 2-mercaptopyridine-N-oxide; N-alkyl-N, N-dimethyl-N-benzylammonium chloride, and a combination thereof.

One method for imparting antimicrobial properties to GAC is by contacting the GAC with an antimicrobial agent in a dry fluidized bed process. In very general terms, this method comprises contacting a specific amount and concentration of antimicrobial solution with GAC in a fluidized bed. The specific amount and concentration of antimicrobial solution is determined based on the pore volume of the GAC.

### EXAMPLE 1

### Fluidized Bed

In this method an aqueous solution of an antimicrobial agent (e.g., triclosan) of known concentration is added to a fluidized bed of GAC. For GAC, acid washed DARCO-12×40 manufactured by Norit Corporation was used. The antimicrobial agent was triclosan in the form of Microban B.

The aqueous solution of Microban B was produced in 0.1N NaOH (0.4%). It is soluble in 0.1N NaOH to the extent of 2.5% concentration. Use of this dilute alkaline solution for acid washed GAC was not expected to cause any problems with the GAC but would only raise the pH slightly towards neutrality. For this example the target concentration of Microban B on the GAC was 5000 ppm. To achieve a Microban B concentration of 5000 ppm, with the pore volume of GAC of approximately 1 ml/g of DARCO-12×40, a 5 mg/ml of Microban B solution was prepared.

To 25 g of GAC approximately 25 ml of this solution was added under fluidized condition in five 5 ml increments. Initially, the carbon is dry and is easy to fluidize. The added solution gradually fills all the pore volume of the GAC until the GAC becomes saturated. The saturated GAC has a wet consistency to it and is hard to fluidize. This serves as an end point after which the sample is dried in a forced air oven at 90° C. for 2-3 hours until the GAC attains a dry consistency.

The quantity of solution added is slightly greater than that needed to fill the pore volume of the GAC. The pore volume of the GAC is a physical property of the GAC that is generally provided by commercial suppliers of GAC.

After fluidization, the material was dried. GAC was then extracted with hot methanol to remove any unadsorbed triclosan. Since Microban B is readily soluble in methanol any unadsorbed and unreacted additive will be extracted.

The concentration of Microban B found in methanol extraction was compared to the original amount added. In this way the concentration of Microban B adsorbed per gram of GAC was determined. The treated material was then subjected to antimicrobial analysis that showed inhibition of bacterial growth on GAC. The treated GAC was also extracted with water to determine if there was any leaching.

### EXAMPLE 2

### Fluidized Bed

The above experiment on infiltration in fluidized bed was also repeated where instead of using 0.1% NaOH to dissolve Microban B, a 0.1% solution of Triton X surfactant was used. The rest of the procedure was identical.

### EXAMPLE 3

### Dry Blending

To 25 g of DARCO-12×40 GAC, 0.2 g of Microban B was added and the material was tumbled for mixing. The amount of Microban B added was in excess of that needed to achieve 5000-ppm concentration because it was anticipated that dry blending could create inhomogeneous distribution within the mixture. This was later on found to be unnecessary.

The blended material was then heated in a forced air oven at 90° C. for 2-3 hours. Microban B additive melts at about 56-58° C. and it is expected to get to liquid state and enter the pores of the GAC at about 90° C.

### EXAMPLE 4

### Traditional Vessel

DARCO GAC was also treated with a traditional vessel type reactor under mechanical stirring, where an excess of solution containing antimicrobial agent is placed in contact with GAC. Three separate vessels containing 25 g of DARCO-GAC were prepared. Three separate 200 ml solutions of Microban B were prepared. The three solutions comprised 125 mg, 62.5 mg, and 25 mg of Microban B dissolved in a 0.1N NaOH solution. The Microban B solutions were then added to the GAC with mechanical agitation. After 2 hours of agitation the Microban B/GAC mixture was filtered and washed repeatedly with distilled water to remove unadsorbed additive. The filtrate was collected for each of the three vessels and analyzed for Microban B. By comparing the filtrate concentration to the original concentrations, it was determined that close to 99% exhaustion of Microban B onto the GAC was achieved in all three vessels. Based on this analysis the GAC samples had approximately 5000, 2500 and 1000 ppm of Microban B.

Two additional samples were produced using the above methodology by using two different mesh sizes of DARCO-GAC both at 5000 ppm of Microban B. One of the samples had 12×40 mesh size while the other finer sample was 80×325 mesh.

### EXAMPLE 5

### Traditional Vessel

A solution of PHMB at 8.3 g/l in water was made and 400 ml of this was contacted with 50 g of DARCO-12×40 GAC in a mechanically stirred vessel. The stirring continued for 2 hours. The contents of the vessel were filtered and washed repeatedly with distilled water to remove unadsorbed PHMB. The original solution and the first filtrate solution were analyzed for PHMB to determine the exhaustion. Over 98% of PHMB was exhausted on the GAC.

The bacteriostatic treatment of the GAC must be such as to the render the antimicrobial agent insoluble in the water that will come in contact with it. It was unexpectedly found out that GAC has such a chemical affinity for organic antimicrobial agents that even with a very short contact time it is possible to remove almost 100% of these agents from solution.

Furthermore, once adsorbed on the surface of carbon, these agents are very hard to remove by repeated boiling water extractions.

### Test Results

The samples produced in examples 1, 2 and 3 and an untreated control GAC were subjected to a quantitative test method called AATCC-100, which contacts the test sample with a known concentration of Gram positive (S. aureus) and Gram negative (E. coli) bacteria and determines the change in concentration of bacteria after 24 hours. Table 1 gives the results expressed as Colony Forming Units (CFU) per 0.1 ml of inoculums. These results show that Microban B™ treated GAC is able to reduce the contacted bacteria by greater than 99% (2 log). From this one can infer that the treated GAC does not serve as a source of food for the bacteria as it does in case of the control where the bacteria count increased by 2 log. The samples were as follows: Sample 1 was a control (DARCO 12×40). Sample 2 was a NaOH solution of Microban B™ Sample 3 was a Triton X solution of Microban B™. Sample 4 was dry blended.

TABLE 1

| | Zero Contact Time | | 24 Hour Contact Time | | Percent Reduction | |
|---|---|---|---|---|---|---|
| Sample | S. aureus | E. coli | S. aureus | E. coli | S. aureus | E. coli |

| | | | | | | |
|---|---|---|---|---|---|---|
| 1 | 3.96 × 10³ | 2.48 × 10⁴ | >1.00 × 10⁶ | >1.00 × 10⁶ | −4512.546125 | −4826.108374 |
| 2 | 3.01 × 10⁴ | 1.15 × 10⁴ | <1.00 × 10² | <1.00 × 10² | 99.71223022 | 99.26739927 |
| 3 | 3.48 × 10³ | 4.90 × 10⁴ | <1.00 × 10² | <1.00 × 10² | 99.53358209 | 99.69135802 |
| 4 | 5.00 × 10² | 2.08 × 10⁴ | <1.00 × 10² | <1.00 × 10² | 99.49874687 | 99.45355191 |

The samples produced in example 4 were subjected to microbiological analysis in a similar way with the AATCC-100 method. These results are given in Table 2. Once again GAC treated with Microban B™ between the concentrations of 5000 to 1000 ppm reduces the bacteria count by 99-100% (or 2 log) while the untreated control increases the concentration of bacteria by 2 log. Sample 1 was the control (DARCO 12×40). Sample 2 had 5000 ppm Microban B™. Sample 3 had 2500 ppm Microban B™. Sample 4 had 1000 ppm Microban B™.

TABLE 2

| | | | Concentration After | | Percent Reduction | |
|---|---|---|---|---|---|---|
| Sam- | Initial Concentration | | 24 Hours | | S. | |
| ple | S. aureus | E. coli | S. aureus | Sample | aureus | E. coli |
| 1 | 3.94 × 10⁴ | 1.58 × 10⁴ | 100 × 10⁶ | 1.00 × 10⁶ | 100% | 100% |
| | | | | | increase | increase |
| 2 | 3.94 × 10⁴ | 1.58 × 10⁴ | 1.00 × 10² | 1.00 × 10² | 99.71% | 99.27% |
| 3 | 1.39 × 10⁶ | 2.03 × 10⁵ | 1.00 × 10² | 1.00 × 10² | 100% | 100% |
| 4 | 6.89 × 10⁵ | 3.08 × 10⁵ | 1.00 × 10² | 1.00 × 10² | 99.99% | 100% |

The two samples of different mesh sizes produced in example 4 and the sample treated with PHMB in example 5 were evaluated by a modified Shaker Flask Test. In this test 5 g of GAC was contacted with 50 ml of buffered solution containing 100,000 CFU/ml of E. coli bacteria in a shaker flask. The mixture was then shaken on a wrist shaker for 12 hours along with an untreated GAC control and a lab control containing only the challenge solution. After 12 hours, the supernatants from the flasks were analyzed for the bacteria. Table 3 shows the results on % reduction. As one can see the GAC treated with Microban B™ and PHMB reduced the bacteria in contact by at least 80-90% in 12 hours while the untreated GAC control and the solution control had nominal reductions that were within the experimental error. Sample 1 was the untreated control. Sample 2 was DARCO #1-2002-11226 treated with Microban B™. Sample 3 was DARCO #2-2002-11224 treated with Microban B™. Sample 4 was DARCO #1 treated with PHMB. Sample 5 was the solution lab control.

TABLE 3

| | Sample 1 | Sample 2 | Sample 3 | Sample 4 | Sample 5 |
|---|---|---|---|---|---|
| Initial | 50 k/ml | 50 k/ml | 50 k/ml | 50 k/ml | 50 k/ml |
| Inoculum | | | | | |
| Exposure | 12 hours | 12 hours | 12 hours | 12 hours | 12 hours |
| Time | | | | | |
| Percent | 2.89% | 87.08% | 90.96% | 88.79% | 0.00% |
| Reduction | | | | | |
| in Bacteria | | | | | |
| Count | | | | | |

All of the above samples were extracted with boiling hot water for their propensity for leaching of antimicrobial agent. In all cases no Microban B™ or PHMB was found within the limit of detection.

DARCO-12×40 treated with 5000 ppm of Microban B™ was compared with untreated GAC, to determine if any of the adsorptive or absorptive properties of the GAC had changed. Table 4 and 5 demonstrate that none of the properties of the carbon had changed as a result of the antimicrobial treatment. Table 4 was the sample treated with 5000 ppm Microban B™. Table 5 was the DARCO control.

TABLE 4

| Test | Result | Unit |
|---|---|---|
| Moisture | 31.82 | % |
| Ash | 15.91 | % db |
| Acid Soluble Ash | 1.78 | % |
| Acid Soluble Iron | 290 | ppm |
| VCM | 7.5 | % db |
| Thermogravimetric Analysis | 1 | |
| Molasses RE, Ground, ai | 84 | ai |
| Molasses RE, Ground, db | 124 | db |
| Water Solubles | 1.04 | % |
| Acid Solubles | 2.21 | % |
| pH | 3.9 | |
| Density, Vibrating Feed | 0.429 | g/ml db |
| Iodine Number | 606 | mg/g |
| Zacher Iron | 17 | ppm |
| Chlorides, Extractable | 240 | ppm |
| Tannin Value | 176 | mg/l db |
| Phosphates | 0 | % |
| Methylene Blue | 11.6 | g/100 g |
| Density, Helium | 2.055 | g/ml |
| Density, Mercury Particle | 0.678 | g/ml db |
| Total Pore Volume | 0.988 | ml/g |
| Skeletal Volume | 0.487 | ml/g |
| Surface Area | 600 | sq. m/g |
| Pore Volume Distribution | 1 | |
| Nitrogen Adsorption/Desorption | 1 | |
| PREP: Drying, Total | 1 | |
| PREP: General Sample | 1 | |
| PREP: Grinding, Spex Mill | 1 | |

TABLE 5

| Test | Result | Unit |
|---|---|---|
| Moisture | 10.09 | % |
| Ash | 16.53 | % db |
| Acid Soluble Ash | 2.91 | % |
| Acid Soluble Iron | 321 | ppm |
| VCM | 6.93 | % db |
| Thermogravimetric Analysis | 1 | |
| Molasses RE, Ground, ai | 102 | ai |
| Molasses RE, Ground, db | 113 | db |
| Water Solubles | 0.71 | % |
| Acid Solubles | 2.69 | % |
| pH | 3.5 | |
| Density, Vibrating Feed | 0.4 | g/ml db |
| Iodine Number | 616 | mg/g |
| Zacher Iron | 51 | ppm |
| Chlorides, Extractable | 145 | ppm |
| Tannin Value | 154 | mg/l db |
| Phosphates | 0 | % |
| Methylene Blue | 11.8 | g/100 g |
| Density, Helium | 2.052 | g/ml |
| Density, Mercury Particle | 0.677 | g/ml db |
| Total Pore Volume | 0.99 | ml/g |
| Skeletal Volume | 0.487 | ml/g |
| Surface Area | 611 | sq. m/g |
| Pore Volume Distribution | 1 | |
| Nitrogen Adsorption/Desorption | 1 | |
| PREP: Drying, Total | 1 | |
| PREP: General Sample | 1 | |
| PREP: Grinding, Spex Mill | 1 | |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A granular activated carbon consisting essentially of:
particles of activated carbon, and
less than 1% by weight of an antimicrobial agent,
wherein said antimicrobial agent does not desorb from said particles when washed in a polar solvent.

2. The granular activated carbon according to claim 1, wherein said antimicrobial agent is an organic antimicrobial agent.

3. The granular activated carbon according to claim 2, wherein said organic antimicrobial agent is a chlorinated phenol.

4. The granular activated carbon according to claim 3, wherein said chlorinated phenol is selected from the group consisting of 2,4,4′-trichloro-2′hydroxy diphenol ether; 5-chloro-2-phenol (2,4-dichlorophenoxy); and a combination thereof.

5. The granular activated carbon according to claim 2, wherein said organic antimicrobial agent is selected from the group consisting of 2-diphenylphenol; diiodomethyl-4-tolylsulfone; N-alkyl-N,N-dimethyl-N-benzylammonium chloride; and a combination thereof.

6. The granular activated carbon according to claim 2, wherein said organic antimicrobial agent is polyhexamethylene biguanide.

7. The granular activated carbon according to claim 1, wherein said antimicrobial agent is an organo-metallic antimicrobial agent.

8. The granular activated carbon according to claim 7, wherein said organo-metallic antimicrobial agent is zinc 2-mercaptopyridine-N-oxide.

9. A fluid filter media comprising a granular activated carbon, wherein the granular activated carbon consists essentially of particles of activated carbon and less than 1% by weight of an antimicrobial agent, wherein said antimicrobial agent does not desorb from said particles when washed in a polar solvent

10. A fluid filter comprising the filter media of claim 9.

11. A method of making granular activated carbon that exhibits antimicrobial properties, the method comprising:
solubilizing a predetermined quantity of an antimicrobial agent, and
contacting said solubilized antimicrobial agent with particles of granular activated carbon.

12. The method according to claim 11, wherein said antimicrobial agent is an organic antimicrobial agent.

13. The method according to claim 12, wherein said organic antimicrobial agent is a chlorinated phenol.

14. The method according to claim 13, wherein said chlorinated phenol is selected from the group consisting of 2,4,4′-trichloro-2′hydroxy diphenol ether; 5-chloro-2-phenol (2,4-dichlorophenoxy); and a combination thereof.

15. The method according to claim 12, wherein said organic antimicrobial agent is selected from the group consisting of 2-diphenylphenol; diiodomethyl-4-tolylsulfone; N-alkyl-N,N-dimethyl-N-benzylammonium chloride; and a combination thereof

16. The method according to claim 12, wherein said organic antimicrobial agent is polyhexamethylene biguanide.

17. The method according to claim 11, wherein said antimicrobial agent is an organo-metallic antimicrobial agent.

18. The method according to claim 17, wherein said organo-metallic antimicrobial agent is zinc 2-mercaptopyridine-N-oxide.

19. A method of making a granular activated carbon that exhibits antimicrobial properties, the method comprising:
melting an antimicrobial agent, and
contacting the antimicrobial agent with particles of granular activated carbon.

20. The method according to claim 19, wherein said antimicrobial agent is an organic antimicrobial agent.

21. The method according to claim 20, wherein said organic antimicrobial agent is a chlorinated phenol.

22. The method according to claim 21, wherein said chlorinated phenol is selected from the group consisting of 2,4,4′-trichloro-2′hydroxy diphenol ether; 5-chloro-2-phenol (2,4-dichlorophenoxy); and a combination thereof.

23. The method according to claim 20, wherein said organic antimicrobial agent is selected from the group consisting of 2-diphenylphenol; diiodomethyl-4-tolylsulfone; N-alkyl-N,N-dimethyl-N-benzylammonium chloride; and a combination thereof

24. The method according to claim 20, wherein said organic antimicrobial agent is polyhexamethylene biguanide.

25. The method according to claim 19, wherein said antimicrobial agent is an organo-metallic antimicrobial agent.

26. The method according to claim 25, wherein said organo-metallic antimicrobial agent is zinc 2-mercaptopyridine-N-oxide.
